(19) United States
(12) Patent Application Publication
(10) Pub. No.: US 2026/0078224 A1
(43) Pub. Date: Mar. 19, 2026

(54) FIRE RETARDANT POLYMERS

(71) Applicant: THE BOARD OF REGENTS OF THE NEVADA SYSTEM OF HIGHER EDUCATION ON BEHALF OF THE UNIVERSITY OF NEVADA, Las Vegas, NV (US)

(72) Inventors: Pradip K. BHOWMIK, Las Vegas, NV (US); Haesook HAN, Las Vegas, NV (US)

(21) Appl. No.: 19/108,683

(22) PCT Filed: Sep. 12, 2023
(86) PCT No.: PCT/US2023/073921

§ 371 Date: Mar. 4, 2025

Related U.S. Application Data
(60) Provisional application No. 63/406,146, filed on Sep. 13, 2022.

(51) Int. Cl. C08G 79/04; C09K 21/14

(52) U.S. Cl. CPC C08G 79/04; C09K 21/14

(57) ABSTRACT

Described herein are fire-retardant polymers, their synthesis, and their applications. In some aspects, the fire-retardant polymers include poly(pyridinium) salts containing phosphine oxide and/or sulfide or sulfone moieties.

### CROSS-REFERENCE TO RELATED APPLICATION(S)

This application claims priority to U.S. Provisional Patent Application No. 63/406,146, filed on Sep. 13, 2022, which is incorporated by reference herein in its entirety.

### TECHNICAL FIELD

Described herein are fire retardant polymers, their synthesis, and their applications. In some aspects, the fire-retardant polymers include poly(pyridinium) salts containing phosphine oxide and/or sulfide or sulfone moieties.

### BACKGROUND

Polymers are extensively used in our everyday lives due to their tunable properties and ease of processing. These qualities render polymers useful for applications ranging from adhesives and lubricants to structural components and windows for aircrafts. However, common polymers are also highly combustible, and produce toxic gases and smoke during combustion. Thus, the development of polymers with fire retardant properties is a major challenge. In recent years, regulations have asked for significantly improved fire performance of materials used in construction, transportation, and clothing. At the same time, some popular fire-resistant compounds containing bromine or chlorine are being phased out due to their detrimental effects on health and the environment during combustion.

What is needed are novel fire-resistant polymers that can be produced and utilized safely and in an environmentally conscious manner.

### SUMMARY

One embodiment described herein is a fire-retardant polymer. In one aspect, the fire-retardant polymer comprises a moiety of formula (I), formula (II), or a combination thereof:

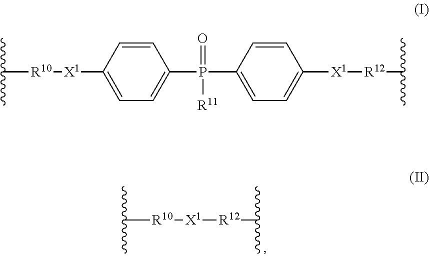

wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl; and
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and a moiety of formula (III):

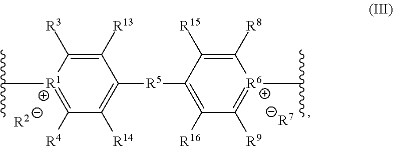

wherein:
R¹ and R⁶ are each N;
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, Ra, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl,
with the proviso that when the polymer comprises a moiety of formula (II) wherein R¹⁰ and
R¹² are each

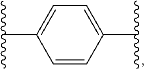 [SMILES: *c1ccc(*)cc1]

X¹ is not SO₂.

In another aspect, the polymer is derived from a monomer of formula (M-I), formula (M-II), or a combination thereof:

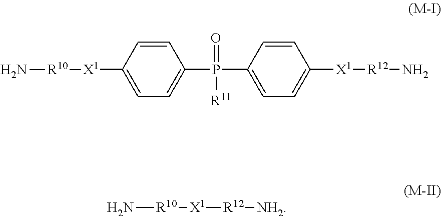

In another aspect, R¹⁰ and R¹² are each unsubstituted phenylene. In another aspect, R¹¹ is unsubstituted phenyl. In another aspect, R² and R⁷ are each TsO⁻. In another aspect, R² and R⁷ are each (Tf)₂N⁻. In another aspect, at least one of R³, R⁴, R¹³, and R¹⁴ is an unsubstituted phenyl. In another aspect, R³ and R⁴ are each unsubstituted phenyl. In another aspect, at least one of R⁸, R⁹, R¹⁵, and R¹⁶ is an unsubstituted phenyl. In another aspect, R¹⁵ and R¹⁶ are each unsubstituted phenyl. In another aspect, the polymer comprises a polymer of formula (P-I), (P-II), or a combination thereof:

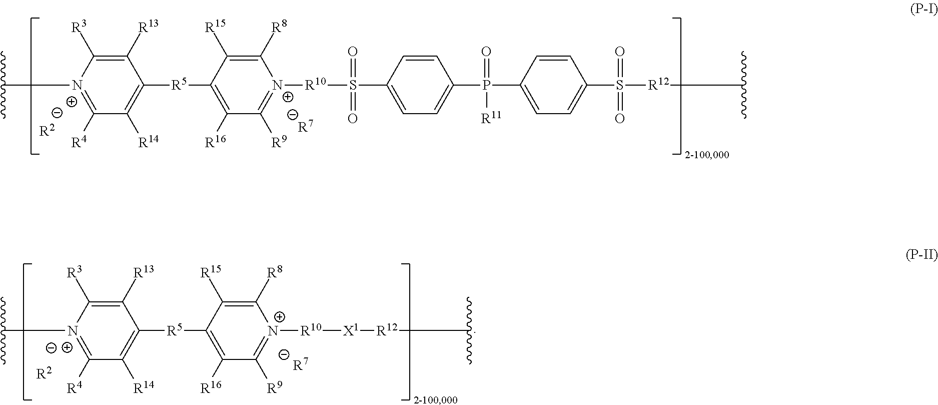

In another aspect, the polymer is a block copolymer or a random copolymer. In another aspect, a fire-retardant device may comprise the polymer comprising the fire-retardant device, wherein the fire-retardant device is a window, a wooden beam, dry wall, a building construction material, a vehicle construction material, a medical device, insulation for an electrical component, a firefighter garment, a printed circuit board, or a paper-product coating.

Another embodiment described herein is a method of making a fire-retardant polymer. In one aspect, the method comprises reacting a monomer with a bis(pyrylium) salt, wherein:
the monomer is a monomer of formula (M-I) or (M-II):

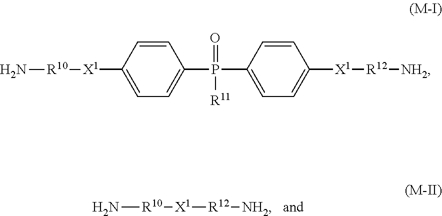

wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl;
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and the bis(pyrylium) salt is a salt of formula:

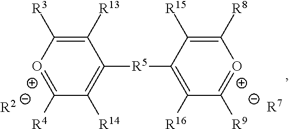

wherein:
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, R⁹, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl,
with the proviso that when the monomer is a monomer of formula (M-II) wherein R¹⁰ and R¹² are each

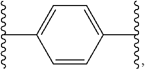 [SMILES: *c1ccc(*)cc1]

X¹ is not SO₂.

In another aspect, R¹⁰ and R¹² are each unsubstituted phenylene. In another aspect, R¹¹ is unsubstituted phenyl. In another aspect, R² and R⁷ are each TsO⁻. In another aspect, R² and R⁷ are each (Tf)₂N⁻. In another aspect, at least one of R³, R⁴, R¹³, and R¹⁴ is an unsubstituted phenyl. In another aspect, R³ and R⁴ are each unsubstituted phenyl. In another aspect, at least one of R⁸, R⁹, R¹⁵, and R¹⁶ is an unsubstituted phenyl. In another aspect, R¹⁵ and R¹⁶ are each unsubstituted phenyl.

Another embodiment described herein is a method of inhibiting combustion. In one aspect, the method comprises applying a fire-retardant polymer to a material, the fire-retardant polymer comprising:
a moiety of formula (I), formula (II), or a combination thereof:

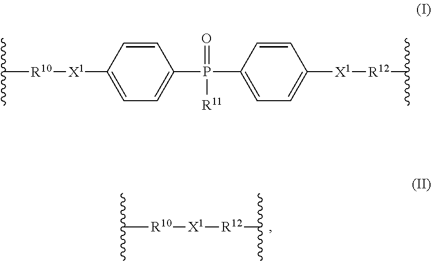

wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl; and
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and
   a moiety of formula (III):

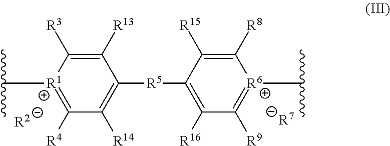

wherein:
R¹ and R⁶ are each N;
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, R⁹, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl.

In one aspect:
R¹⁰ and R¹² are each unsubstituted phenylene;
R¹¹ is unsubstituted phenyl; and
R² and R⁷ are each TsO⁻ or (Tf)₂N⁻.

In another aspect, the fire-retardant polymer comprises a polymer of formula (P-I), (P-II), or a combination thereof:

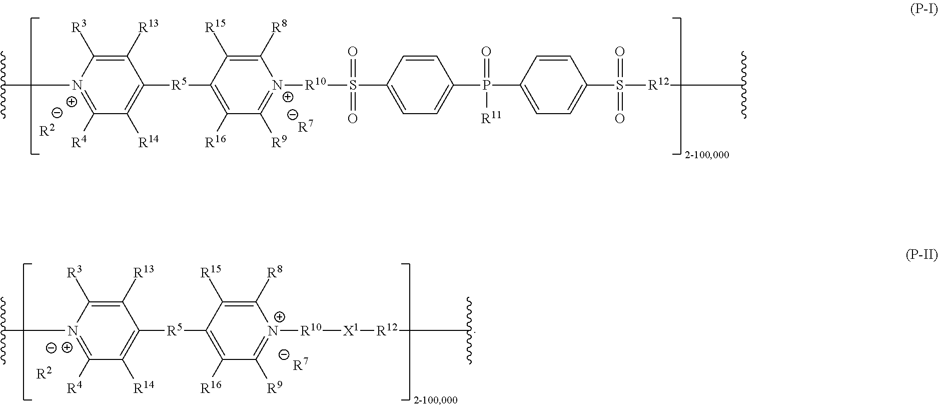

### DESCRIPTION OF THE DRAWINGS

FIG. 1 shows an exemplary bis(pyrylium) salt (M) and exemplary diamine monomers (I-IV) for preparing the poly(pyridinium salt)s.

FIG. 2 shows the structures of exemplary poly(pyridinium) salts. TsO⁻ is tosylate and (Tf)₂N⁻ is bistriflimide.

FIG. 3A-B show the ¹H (FIG. 3A) and ¹³C (FIG. 3B) NMR spectra of p-BASOPO.

FIG. 4A-B show the ¹H (FIG. 4A) and ¹³C (FIG. 4B) NMR spectra of polymer AP5.

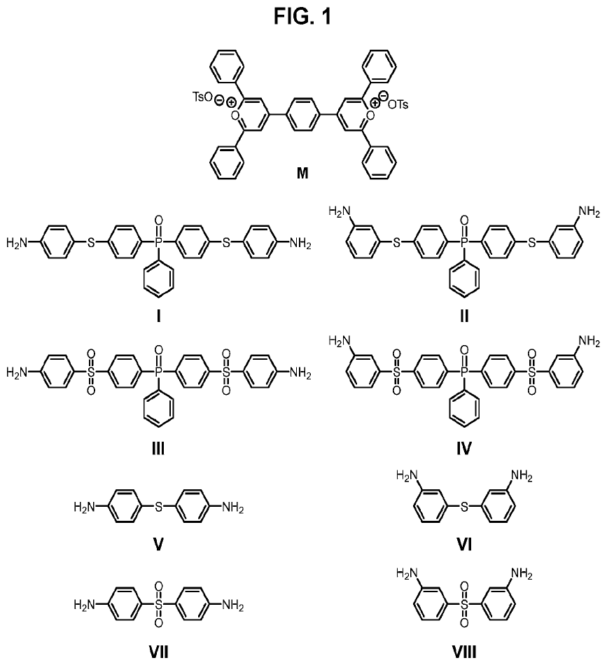

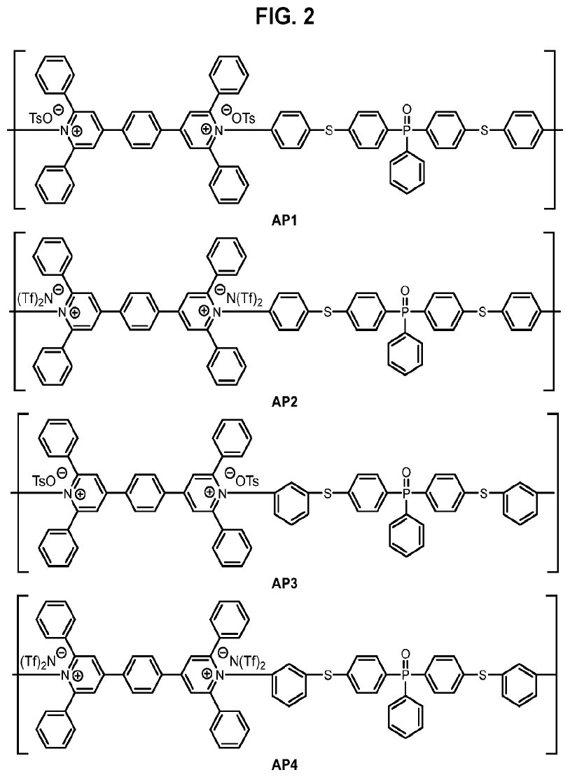

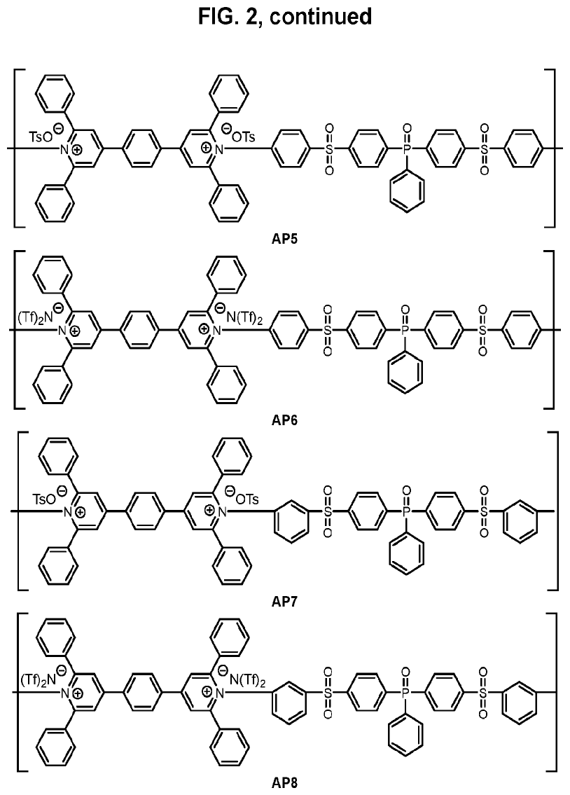

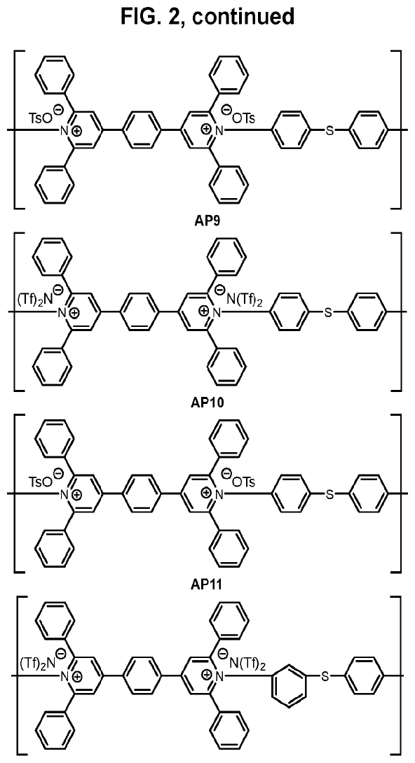

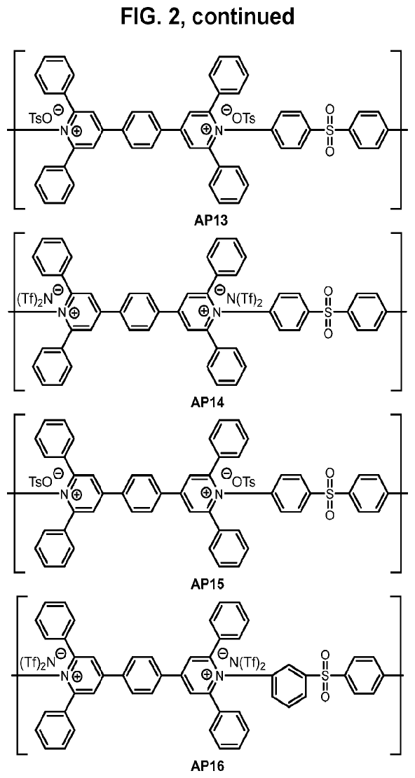

### DETAILED DESCRIPTION

Unless otherwise defined, all technical and scientific terms used herein have the same meaning as commonly understood by one of ordinary skill in the art. For example, any nomenclatures used in connection with, and techniques of synthetic chemistry described herein are well known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to ±10% of any value within the range or within 3 or more standard deviations, including the end points.

As used herein, the terms “control,” or “reference” are used herein interchangeably. A “reference” or “control” level may be a predetermined value or range, which is employed as a baseline or benchmark against which to assess a measured result. “Control” also refers to control experiments or control cells.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

The term “alkoxy,” as used herein, refers to a group —O-alkyl. Representative examples of alkoxy include, but are not limited to, methoxy, ethoxy, propoxy, 2-propoxy, butoxy and tert-butoxy.

The term “alkyl,” as used herein, means a straight or branched, saturated hydrocarbon chain. The term “lower alkyl” or “C₁₋₄alkyl” means a straight or branched chain hydrocarbon containing from 1 to 6 carbon atoms. The term “C₁alkyl” means a straight or branched chain hydrocarbon containing from 1 to 4 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkenyl,” as used herein, means a straight or branched, hydrocarbon chain containing at least one carbon-carbon double bond.

The term “alkoxyalkyl,” as used herein, refers to an alkoxy group, as defined herein, appended to the parent molecular moiety through an alkyl group, as defined herein.

The term “alkoxyfluoroalkyl,” as used herein, refers to an alkoxy group, as defined herein, appended to the parent molecular moiety through a fluoroalkyl group, as defined herein.

The term “alkylene,” as used herein, refers to a divalent group derived from a straight or branched chain hydrocarbon of 1 to 10 carbon atoms, for example, of 2 to 5 carbon atoms. Representative examples of alkylene include, but are not limited to, —CH₂—, —CD₂-, —CH₂CH₂—, —CH₂CH₂CH₂—, —CH₂CH₂CH₂CH₂—, and —CH₂CH₂CH₂CH₂CH₂—.

The term “alkylamino,” as used herein, means at least one alkyl group, as defined herein, is appended to the parent molecular moiety through an amino group, as defined herein.

The term “amide,” as used herein, means —C(O)NR— or —NRC(O)—, wherein R may be hydrogen, alkyl, cycloalkyl, aryl, heteroaryl, heterocycle, alkenyl, or heteroalkyl.

The term “aminoalkyl,” as used herein, means at least one amino group, as defined herein, is appended to the parent molecular moiety through an alkylene group, as defined herein.

The term “amino,” as used herein, means —NRₓR_{y}, wherein Rₓ and R_{y} may be hydrogen, alkyl, cycloalkyl, aryl, heteroaryl, heterocycle, alkenyl, or heteroalkyl. In the case of an aminoalkyl group or any other moiety where amino appends together two other moieties, amino may be —NRₓ—, wherein Rₓ may be hydrogen, alkyl, cycloalkyl, aryl, heteroaryl, heterocycle, alkenyl, or heteroalkyl.

The term “aryl,” as used herein, refers to a phenyl or a phenyl appended to the parent molecular moiety and fused to a cycloalkane group (e.g., the aryl may be indan-4-yl), fused to a 6-membered arene group (i.e., the aryl is naphthyl), or fused to a non-aromatic heterocycle (e.g., the aryl may be benzo[d][1,3]dioxol-5-yl). The term “phenyl” is used when referring to a substituent and the term 6-membered arene is used when referring to a fused ring. The 6-membered arene is monocyclic (e.g., benzene or benzo). The aryl may be monocyclic (phenyl) or bicyclic (e.g., a 9- to 12-membered fused bicyclic system).

The term “cyanoalkyl,” as used herein, means at least one —CN group, is appended to the parent molecular moiety through an alkylene group, as defined herein.

The term “cyanofluoroalkyl,” as used herein, means at least one —CN group, is appended to the parent molecular moiety through a fluoroalkyl group, as defined herein.

The term “cycloalkoxy,” as used herein, refers to a cycloalkyl group, as defined herein, appended to the parent molecular moiety through an oxygen atom.

The term “cycloalkyl” or “cycloalkane,” as used herein, refers to a saturated ring system containing all carbon atoms as ring members and zero double bonds. The term “cycloalkyl” is used herein to refer to a cycloalkane when present as a substituent. A cycloalkyl may be a monocyclic cycloalkyl (e.g., cyclopropyl), a fused bicyclic cycloalkyl (e.g., decahydronaphthalenyl), or a bridged cycloalkyl in which two non-adjacent atoms of a ring are linked by an alkylene bridge of 1, 2, 3, or 4 carbon atoms (e.g., bicyclo[2.2.1]heptanyl).

Representative examples of cycloalkyl include, but are not limited to, cyclopropyl, cyclobutyl, cyclopentyl, cyclohexyl, cycloheptyl, cyclooctyl, cyclononyl, cyclodecyl, adamantyl, and bicyclo[1.1.1]pentanyl.

The term “cycloalkenyl” or “cycloalkene,” as used herein, means a non-aromatic monocyclic or multicyclic ring system containing all carbon atoms as ring members and at least one carbon-carbon double bond and preferably having from 5-10 carbon atoms per ring. The term “cycloalkenyl” is used herein to refer to a cycloalkene when present as a substituent. A cycloalkenyl may be a monocyclic cycloalkenyl (e.g., cyclopentenyl), a fused bicyclic cycloalkenyl (e.g., octahydronaphthalenyl), or a bridged cycloalkenyl in which two non-adjacent atoms of a ring are linked by an alkylene bridge of 1, 2, 3, or 4 carbon atoms (e.g., bicyclo[2.2.1]heptenyl).

Exemplary monocyclic cycloalkenyl rings include cyclopentenyl, cyclohexenyl or cycloheptenyl. Exemplary monocyclic cycloalkenyl rings include cyclopentenyl, cyclohexenyl or cycloheptenyl.

The term “carbocyclyl” means a “cycloalkyl” or a “cycloalkenyl.” The term “carbocycle” means a “cycloalkane” or a “cycloalkene.” The term “carbocyclyl” refers to a “carbocycle” when present as a substituent.

The terms cycloalkylene and heterocyclylene refer to divalent groups derived from the base ring, i.e., cycloalkane, heterocycle. For purposes of illustration, examples of cycloalkylene and heterocyclylene include, respectively,

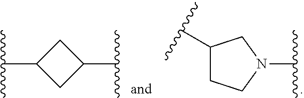 [SMILES: *C1CC(*)C1 ; *C1CCN(*)C1]

Cycloalkylene and heterocyclylene include a geminal divalent groups such as 1,1-C₃₋₆cycloalkylene

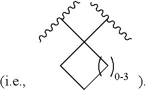

A further example is 1,1-cyclopropylene

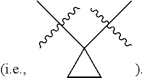 [SMILES: *C1(*)CC1]

The term “fluoroalkyl,” as used herein, means an alkyl group, as defined herein, in which one, two, three, four, five, six, seven or eight hydrogen atoms are replaced by fluorine. Representative examples of fluoroalkyl include, but are not limited to, 2-fluoroethyl, 2,2,2-trifluoroethyl, trifluoromethyl, difluoromethyl, pentafluoroethyl, and trifluoropropyl such as 3,3,3-trifluoropropyl.

The term “fluoroalkylene,” as used herein, means an alkylene group, as defined herein, in which one, two, three, four, five, six, seven or eight hydrogen atoms are replaced by fluorine. Representative examples of fluoroalkyl include, but are not limited to —CF₂—, —CH₂CF₂—, 1,2-difluoroethylene, 1,1,2,2-tetrafluoroethylene, 1,3,3,3-tetrafluoropropylene, 1,1,2,3,3-pentafluoropropylene, and perfluoropropylene such as 1,1,2,2,3,3-hexafluoropropylene.

The term “halogen” or “halo,” as used herein, means Cl, Br, I, or F.

The term “haloalkyl,” as used herein, means an alkyl group, as defined herein, in which one, two, three, four, five, six, seven or eight hydrogen atoms are replaced by a halogen.

The term “haloalkoxy,” as used herein, means at least one haloalkyl group, as defined herein, is appended to the parent molecular moiety through an oxygen atom.

The term “halocycloalkyl,” as used herein, means a cycloalkyl group, as defined herein, in which one or more hydrogen atoms are replaced by a halogen.

The term “heteroalkyl,” as used herein, means an alkyl group, as defined herein, in which one or more of the carbon atoms has been replaced by a heteroatom selected from S, O, P and N. Representative examples of heteroalkyls include, but are not limited to, alkyl ethers, secondary and tertiary alkyl amines, amides, and alkyl sulfides.

The term “heteroaryl,” as used herein, refers to an aromatic monocyclic heteroatom-containing ring (monocyclic heteroaryl) or a bicyclic ring system containing at least one monocyclic heteroaromatic ring (bicyclic heteroaryl). The term “heteroaryl” is used herein to refer to a heteroarene when present as a substituent. The monocyclic heteroaryl are five or six membered rings containing at least one heteroatom independently selected from the group consisting of N, O and S (e.g., 1, 2, 3, or 4 heteroatoms independently selected from O, S, and N). The five membered aromatic monocyclic rings have two double bonds, and the six membered aromatic monocyclic rings have three double bonds. The bicyclic heteroaryl is an 8- to 12-membered ring system and includes a fused bicyclic heteroaromatic ring system (i.e., 10π electron system) such as a monocyclic heteroaryl ring fused to a 6-membered arene (e.g., quinolin-4-yl, indol-1-yl), a monocyclic heteroaryl ring fused to a monocyclic heteroarene (e.g., naphthyridinyl), and a phenyl fused to a monocyclic heteroarene (e.g., quinolin-5-yl, indol-4-yl). A bicyclic heteroaryl/heteroarene group includes a 9-membered fused bicyclic heteroaromatic ring system having four double bonds and at least one heteroatom contributing a lone electron pair to a fully aromatic 10π electron system, such as ring systems with a nitrogen atom at the ring junction (e.g., imidazopyridine) or a benzoxadiazolyl. A bicyclic heteroaryl also includes a fused bicyclic ring system composed of one heteroaromatic ring and one non-aromatic ring such as a monocyclic heteroaryl ring fused to a monocyclic carbocyclic ring (e.g., 6,7-dihydro-5H-cyclopenta[b]pyridinyl), or a monocyclic heteroaryl ring fused to a monocyclic heterocycle (e.g., 2,3-dihydrofuro[3,2-b]pyridinyl). The bicyclic heteroaryl is attached to the parent molecular moiety at an aromatic ring atom. Other representative examples of heteroaryl include, but are not limited to, indolyl (e.g., indol-1-yl, indol-2-yl, indol-4-yl), pyridinyl (including pyridin-2-yl, pyridin-3-yl, pyridin-4-yl), pyrimidinyl, pyrazinyl, pyridazinyl, pyrazolyl (e.g., pyrazol-4-yl), pyrrolyl, benzopyrazolyl, 1,2,3-triazolyl (e.g., triazol-4-yl), 1,3,4-thiadiazolyl, 1,2,4-thiadiazolyl, 1,3,4-oxadiazolyl, 1,2,4-oxadiazolyl, imidazolyl, thiazolyl (e.g., thiazol-4-yl), isothiazolyl, thienyl, benzimidazolyl (e.g., benzimidazol-5-yl), benzothiazolyl, benzoxazolyl, benzoxadiazolyl, benzothienyl, benzofuranyl, isobenzofuranyl, furanyl, oxazolyl, isoxazolyl, purinyl, isoindolyl, quinoxalinyl, indazolyl (e.g., indazol-4-yl, indazol-5-yl), quinazolinyl, 1,2,4-triazinyl, 1,3,5-triazinyl, isoquinolinyl, quinolinyl, imidazo[1,2-a]pyridinyl (e.g., imidazo[1,2-a]pyridin-6-yl), naphthyridinyl, pyridoimidazolyl, thiazolo[5,4-b]pyridin-2-yl, and thiazolo[5,4-d]pyrimidin-2-yl.

The term “heterocycle” or “heterocyclic,” as used herein, means a monocyclic heterocycle, a bicyclic heterocycle, or a tricyclic heterocycle. The term “heterocyclyl” is used herein to refer to a heterocycle when present as a substituent. The monocyclic heterocycle is a three-, four-, five-, six-, seven-, or eight-membered ring containing at least one heteroatom independently selected from the group consisting of O, N, and S. The three- or four-membered ring contains zero or one double bond, and one heteroatom selected from the group consisting of O, N, and S. The five-membered ring contains zero or one double bond and one, two or three heteroatoms selected from the group consisting of O, N and S. The six-membered ring contains zero, one or two double bonds and one, two, or three heteroatoms selected from the group consisting of O, N, and S. The seven- and eight-membered rings contains zero, one, two, or three double bonds and one, two, or three heteroatoms selected from the group consisting of O, N, and S. Representative examples of monocyclic heterocyclyls include, but are not limited to, azetidinyl, azepanyl, aziridinyl, diazepanyl, 1,3-dioxanyl, 1,3-dioxolanyl, 1,3-dithiolanyl, 1,3-dithianyl, imidazolinyl, imidazolidinyl, isothiazolinyl, isothiazolidinyl, isoxazolinyl, isoxazolidinyl, morpholinyl, 2-oxo-3-piperidinyl, 2-oxoazepan-3-yl, oxadiazolinyl, oxadiazolidinyl, oxazolinyl, oxazolidinyl, oxetanyl, oxepanyl, oxocanyl, piperazinyl, piperidinyl, pyranyl, pyrazolinyl, pyrazolidinyl, pyrrolinyl, pyrrolidinyl, tetrahydrofuranyl, tetrahydropyranyl, tetrahydropyridinyl, tetrahydrothienyl, thiadiazolinyl, thiadiazolidinyl, 1,2-thiazinanyl, 1,3-thiazinanyl, thiazolinyl, thiazolidinyl, thiomorpholinyl, 1,1-dioxidothiomorpholinyl (thiomorpholine sulfone), thiopyranyl, and trithianyl. The bicyclic heterocycle is a monocyclic heterocycle fused to a 6-membered arene, or a monocyclic heterocycle fused to a monocyclic cycloalkane, or a monocyclic heterocycle fused to a monocyclic cycloalkene, or a monocyclic heterocycle fused to a monocyclic heterocycle, or a monocyclic heterocycle fused to a monocyclic heteroarene, or a spiro heterocycle group, or a bridged monocyclic heterocycle ring system in which two non-adjacent atoms of the ring are linked by an alkylene bridge of 1, 2, 3, or 4 carbon atoms, or an alkenylene bridge of two, three, or four carbon atoms. The bicyclic heterocyclyl is attached to the parent molecular moiety at a non-aromatic ring atom (e.g., indolin-1-yl). Representative examples of bicyclic heterocyclyls include, but are not limited to, chroman-4-yl, 2,3-dihydrobenzofuran-2-yl, 2,3-dihydrobenzothien-2-yl, 1,2,3,4-tetrahydroisoquinolin-2-yl, 2-azaspiro[3.3]heptan-2-yl, 2-oxa-6-azaspiro[3.3]heptan-6-yl, azabicyclo[2.2.1]heptyl (including 2-azabicyclo[2.2.1]hept-2-yl), azabicyclo[3.1.0]hexanyl (including 3-azabicyclo[3.1.0]hexan-3-yl), 2,3-dihydro-1H-indol-1-yl, isoindolin-2-yl, octahydrocyclopenta[c]pyrrolyl, octahydropyrrolopyridinyl, tetrahydroisoquinolinyl, 7-oxabicyclo[2.2.1]heptanyl, hexahydro-2H-cyclopenta[b]furanyl, 2-oxaspiro[3.3]heptanyl, 3-oxaspiro[5.5]undecanyl, 6-oxaspiro[2.5]octan-1-yl, and 3-oxabicyclo[3.1.0]hexan-6-yl. Tricyclic heterocycles are exemplified by a bicyclic heterocycle fused to a 6-membered arene, or a bicyclic heterocycle fused to a monocyclic cycloalkane, or a bicyclic heterocycle fused to a monocyclic cycloalkene, or a bicyclic heterocycle fused to a monocyclic heterocycle, or a bicyclic heterocycle in which two non-adjacent atoms of the bicyclic ring are linked by an alkylene bridge of 1, 2, 3, or 4 carbon atoms, or an alkenylene bridge of two, three, or four carbon atoms. Examples of tricyclic heterocycles include, but are not limited to, octahydro-2,5-epoxypentalene, hexahydro-2H-2,5-methanocyclopenta[b]furan, hexahydro-1H-1,4-methanocyclopenta[c]furan, aza-adamantane (1-azatricyclo[3.3.1.13,7]decane), and oxa-adamantane (2-oxatricyclo[3.3.1.13,7]decane). The monocyclic, bicyclic, and tricyclic heterocyclyls are connected to the parent molecular moiety at a non-aromatic ring atom.

The term “hydroxyl” or “hydroxy,” as used herein, means an —OH group.

The term “hydroxyalkyl,” as used herein, means at least one —OH group, is appended to the parent molecular moiety through an alkylene group, as defined herein.

The term “hydroxyfluoroalkyl,” as used herein, means at least one —OH group, is appended to the parent molecular moiety through a fluoroalkyl group, as defined herein.

Terms such as “alkyl,” “cycloalkyl,” “alkylene,” etc. may be preceded by a designation indicating the number of atoms present in the group in a particular instance (e.g., “C₁₋₄alkyl,” “C₃₋₆cycloalkyl,” “C₁₋₄alkylene”). These designations are used as generally understood by those skilled in the art. For example, the representation “C” followed by a subscripted number indicates the number of carbon atoms present in the group that follows. Thus, “C₃alkyl” is an alkyl group with three carbon atoms (i.e., n-propyl, isopropyl). Where a range is given, as in “C₁₋₄,” the members of the group that follows may have any number of carbon atoms falling within the recited range. A “C₁₋₄alkyl,” for example, is an alkyl group having from 1 to 4 carbon atoms, however arranged (i.e., straight chain or branched).

The term “substituted” refers to a group that may be further substituted with one or more non-hydrogen substituent groups. Substituent groups include, but are not limited to, halogen, ═O (oxo), ═S (thioxo), cyano, nitro, fluoroalkyl, alkoxyfluoroalkyl, fluoroalkoxy, alkyl, alkenyl, alkynyl, haloalkyl, haloalkoxy, heteroalkyl, cycloalkyl, cycloalkenyl, aryl, heteroaryl, heterocycle, cycloalkylalkyl, heteroarylalkyl, arylalkyl, hydroxy, hydroxyalkyl, alkoxy, alkoxyalkyl, alkylene, aryloxy, phenoxy, benzyloxy, amino, alkylamino, acylamino, aminoalkyl, arylamino, sulfonylamino, sulfinylamino, sulfonyl, alkylsulfonyl, arylsulfonyl, aminosulfonyl, sulfinyl, —COOH, ketone, amide, carbamate, and acyl.

It will be apparent to one of ordinary skill in the relevant art that suitable modifications and adaptations to the compositions, formulations, methods, processes, and applications described herein can be made without departing from the scope of any embodiments or aspects thereof. The compositions and methods provided are exemplary and are not intended to limit the scope of any of the specified embodiments. All of the various embodiments, aspects, and options disclosed herein can be combined in any variations or iterations. The scope of the compositions, formulations, methods, and processes described herein include all actual or potential combinations of embodiments, aspects, options, examples, and preferences herein described. The exemplary compositions and formulations described herein may omit any component, substitute any component disclosed herein, or include any component disclosed elsewhere herein. The ratios of the mass of any component of any of the compositions or formulations disclosed herein to the mass of any other component in the formulation or to the total mass of the other components in the formulation are hereby disclosed as if they were expressly disclosed. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

Various embodiments and aspects of the inventions described herein are summarized by the following clauses:
Clause 1. A fire-retardant polymer, the polymer comprising:
   a moiety of formula (I), formula (II), or a combination thereof:

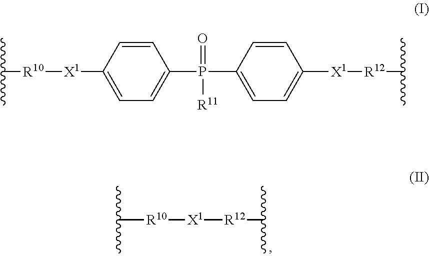

wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl; and
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and
a moiety of formula (111):

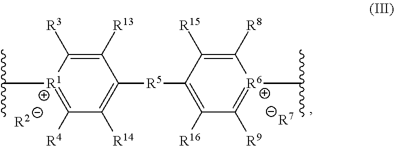

wherein:
R¹ and R⁶ are each N;
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, R⁹, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl,
with the proviso that when the polymer comprises a moiety of formula (II) wherein R¹⁰ and
R¹² are each

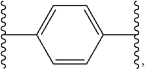 [SMILES: *c1ccc(*)cc1]

X¹ is not SO₂.
Clause 2. The polymer of clause 1, wherein the polymer is derived from a monomer of formula (M-I), formula (M-II), or a combination thereof:

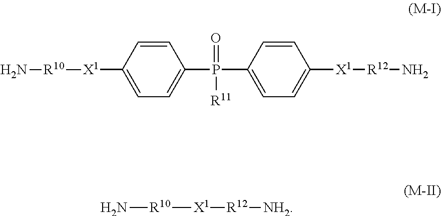

Clause 3. The polymer of clause 1 or 2, wherein R¹⁰ and R¹² are each unsubstituted phenylene.
Clause 4. The polymer of any one of clauses 1-3, wherein R¹¹ is unsubstituted phenyl.
Clause 5. The polymer of any one of clauses 1-4, wherein R² and R⁷ are each TsO⁻.
Clause 6. The polymer of any one of clauses 1-4, wherein R² and R⁷ are each (Tf)₂N⁻.
Clause 7. The polymer of any one of clauses 1-6, wherein at least one of R³, R⁴, R¹³, and R¹⁴ is an unsubstituted phenyl.
Clause 8. The polymer of clause 7, wherein R³ and R⁴ are each unsubstituted phenyl.
Clause 9. The polymer of any one of clauses 1-8, wherein at least one of R⁸, R⁹, R¹⁵, and R¹⁶ is an unsubstituted phenyl.
Clause 10. The polymer of clause 9, wherein R¹⁵ and R¹⁶ are each unsubstituted phenyl.
Clause 11. The polymer of any one of clauses 1-10, wherein the polymer comprises a polymer of formula (P-I), (P-II), or a combination thereof:

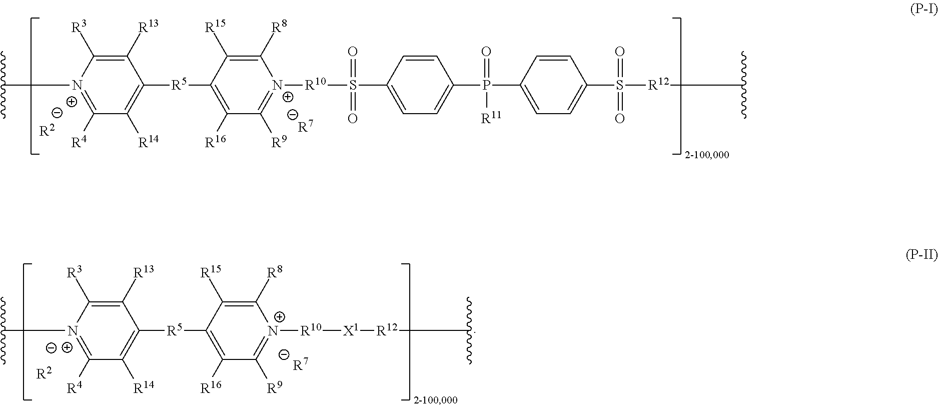

Clause 12. The polymer of any one of clauses 1-11, wherein the polymer is a block copolymer or a random copolymer.
Clause 13. A fire-retardant device comprising the polymer of any one of clauses 1-12, wherein the fire-retardant device is a window, a wooden beam, dry wall, a building construction material, a vehicle construction material, a medical device, insulation for an electrical component, a firefighter garment, a printed circuit board, or a paper-product coating.
Clause 14. A method of making a fire-retardant polymer, the method comprising reacting a monomer with a bis(pyrylium) salt, wherein:
   the monomer is a monomer of formula (M-I) or (M-II):

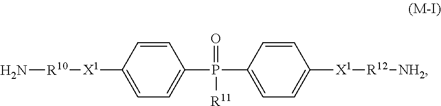

and
wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl;
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and
   the bis(pyrylium) salt is a salt of formula:

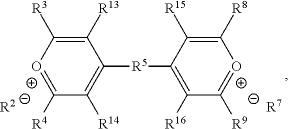

wherein:
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, R⁹, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl,
with the proviso that when the monomer is a monomer of formula (M-II) wherein R¹⁰ and R¹² are each

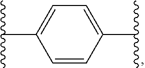 [SMILES: *c1ccc(*)cc1]

X¹ is not SO₂.
Clause 15. The method of clause 14, wherein R¹⁰ and R¹² are each unsubstituted phenylene.
Clause 16. The method of clause 14 or 15, wherein R¹¹ is unsubstituted phenyl.
Clause 17. The method of any one of clauses 14-16, wherein R² and R⁷ are each TsO⁻.
Clause 18. The method of any one of clauses 14-16, wherein R² and R⁷ are each (Tf)₂N⁻.
Clause 19. The method of any one of clauses 14-18, wherein at least one of R³, R⁴, R¹³, and R¹⁴ is an unsubstituted phenyl.
Clause 20. The method of clause 19, wherein R³ and R⁴ are each unsubstituted phenyl.
Clause 21. The method of any one of clauses 14-20, wherein at least one of R⁸, R⁹, R¹⁵, and R¹⁶ is an unsubstituted phenyl.
Clause 22. The method of clause 21, wherein R¹⁵ and R¹⁶ are each unsubstituted phenyl.
Clause 23. A method of inhibiting combustion, the method comprising applying a fire-retardant polymer to a material, the fire-retardant polymer comprising:
   a moiety of formula (I), formula (II), or a combination thereof:

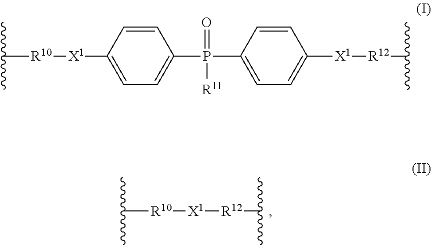

wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl; and
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and
   a moiety of formula (111):

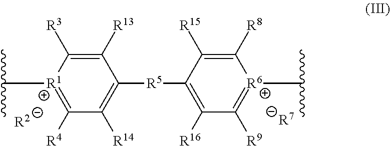

wherein:
R¹ and R⁶ are each N;
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, R⁹, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl.
Clause 24. The method of clause 23, wherein:
   R¹⁰ and R¹² are each unsubstituted phenylene;
   R¹¹ is unsubstituted phenyl; and
   R² and R⁷ are each TsO⁻ or (Tf)₂N⁻.
Clause 25. The method of clause 23 or 24, wherein the fire-retardant polymer comprises a polymer of formula (P-I), (P-II), or a combination thereof:

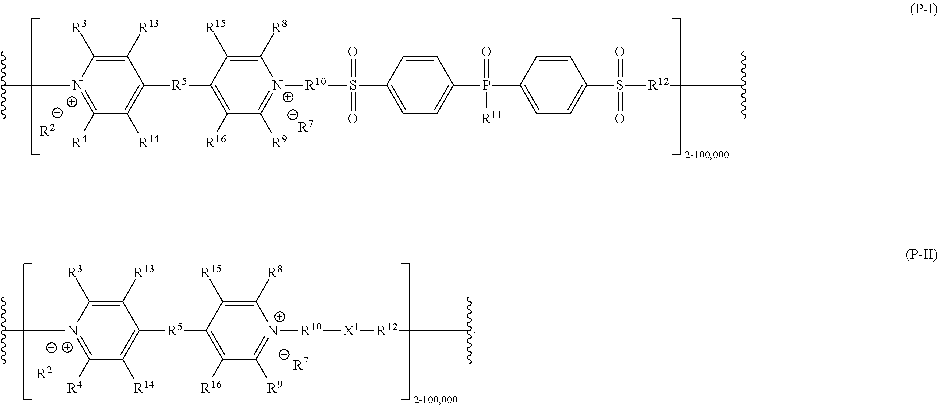

### EXAMPLES

### Example 1

### General Synthesis Methods

Monomers of formula M-I and polymers of formula P-I may be prepared by synthetic processes. R¹⁰, R¹¹, and R¹², are as defined herein.

Abbreviations which have been used in the descriptions of the Scheme that follow are:
PhPOCl₂ is phenylphosphonic dichloride; and
DMAc is dimethylacetamide.

Monomers of formula (M-I) or any of its subformulas may be synthesized as shown in the following scheme.

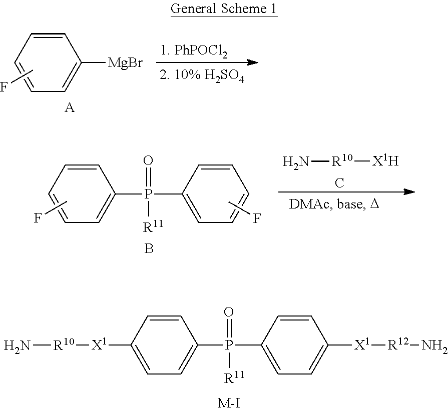

As shown in General Scheme 1, compounds of formula A may be reacted with PhPOCl₂, followed by quenching with 10% H₂SO₄ to form an intermediate of formula B. Intermediate compounds of formula B may be reacted with an amine of formula C under basic conditions to form monomers of formula M-I.

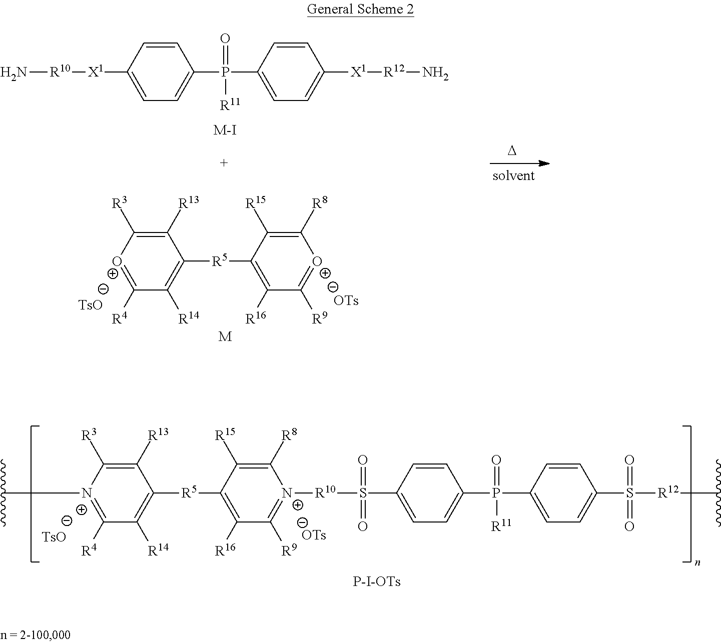

As shown in General Scheme 2, monomers of formula M-I may be reacted with a bis(pyrylium) salt of formula M to form a polymer of formula P-I-OTs.

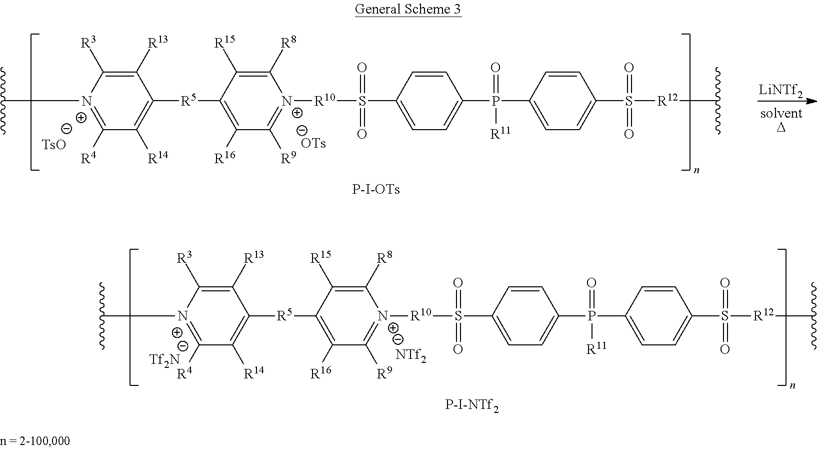

As shown in General Scheme 3, polymers of formula P-I-OTs may be reacted with LiNTf₂ to form a polymer of formula P-I-NTf₂.

### Example 2

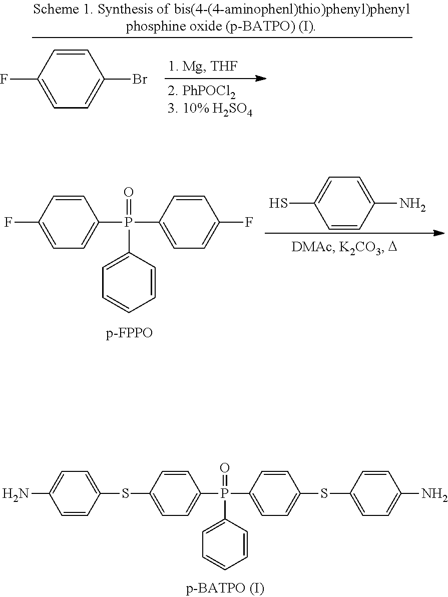 [SMILES: Fc1ccc(Br)cc1 ; O=P(c1ccccc1)(c1ccc(F)cc1)c1ccc(F)cc1 ; Nc1ccc(S)cc1 ; Nc1ccc(Sc2ccc(P(=O)(c3ccccc3)c3ccc(Sc4ccc(N)cc4)cc3)cc2)cc1]

### Synthesis of bis(4-(4-aminophenl)thio)phenyl)phenyl phosphine oxide (p-BATPO)

The p-BATPO compound was synthesized according to Scheme 1. First, to a slurry of 2.2 g of magnesium (Mg) in 50 mL of tetrahydrofuran (THF) in an ice bath, a solution of p-bromofluorobenzene (15 g) in THE (40 mL) was added dropwise over a period of 3 h. This was allowed to stir overnight at room temperature. During this time, a gray colored solution appeared. The mixture was cooled to 0° C. and a solution of phenylphosphonic dichloride (8.35 g) in 20 mL THF was added dropwise over a period of 3-4 h with stirring. The mixture was then warmed to room temperature and stirred for 12 h. The mixture was quenched with 10% H₂SO₄ and stirred for 1 h. Ether (200 mL) was added to separate the organic layer, and the aqueous layer was extracted with ether (3×75 mL). The combined ethereal extract was washed with NaHCO₃ solution and water, and dried over sodium sulfate. The solvent was removed under reduced pressure to furnish a light brown oil. The crude product was purified by crystallization from THF/hexane (1:1) to afford bis(4-fluorophenyl)-phenylphosphineoxide (p-FPPO) as an off-white solid (89% yield), mp 128-130° C.

In the second step, a magnetically stirred mixture of p-FPPO (5.00 g, 0.016 mol), 4-aminobenzenethiol (4.38 g, 0.038 mol) and K₂CO₃ (5.53 g, 0.04 mol) in dimethylacetamide (15 mL) was heated to reflux for 24 h in nitrogen. The reaction mixture was then cooled to rt and poured into ice water with vigorous stirring. The precipitated yellow solid product was collected in a Buchner funnel using vacuum filtration and washed well with water to remove the salt and unreacted 4-aminobenzenethiol to give the NMR pure product p-BATPO (7.97 g, 0.0152 mol) with 95% yield. The chemical structure was confirmed by ¹H and ¹³C NMR and differential scanning calorimetry (DSC) analysis (mp 133-134° C.).

### Example 3

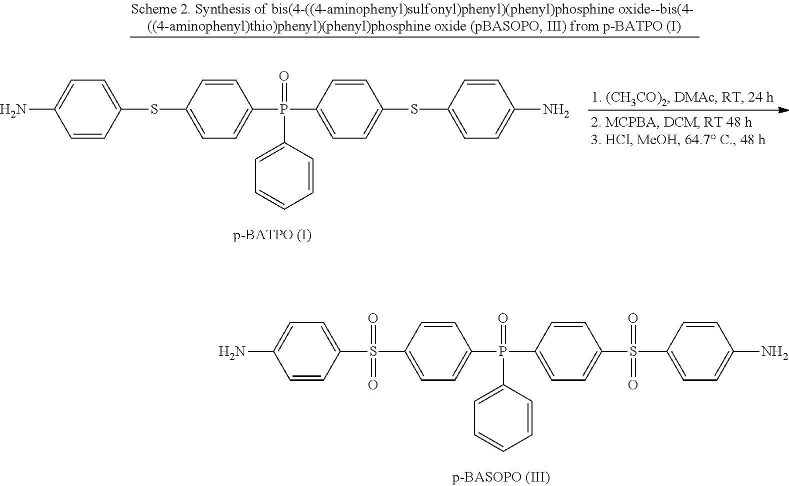 [SMILES: Nc1ccc(Sc2ccc(P(=O)(c3ccccc3)c3ccc(Sc4ccc(N)cc4)cc3)cc2)cc1 ; Nc1ccc(S(=O)(=O)c2ccc(P(=O)(c3ccccc3)c3ccc(S(=O)(=O)c4ccc(N)cc4)cc3)cc2)cc1]

### Synthesis of p-BASOPO (III)

The p-BASOPO compound was synthesized according to Scheme 2. In Step 1, the p-BATPO (1) (1.5 g, 2.859 mmol) and an excess (CH₃CO)₂O (0.876 g, 8.581 mmol) were added to an Erlenmeyer flask containing 30 mL of dimethyl acetamide. The reaction was stirred at room temperature for 24 h. At the end of the reaction, the reaction mixture was poured into the ice-cooled water in a beaker with stirring resulting in the precipitation of the product. Saturated sodium bicarbonate solution was added slowly to neutralize the acid. The pure compound of acetylated p-BATPO (1.476 g, 2.425 mmol) was obtained by vacuum filtration. The yield of this reaction was 85%.

In Step 2, the acetylated p-BATPO (1.0 g, 1.643 mmol) was added to an Erlenmeyer flask containing 100 mL of methylene chloride. The flask was placed in an ice bath, and then meta-chloroperbenzoic acid (1.276 g, 7.394 mmol) was slowly added to the flask. The reaction was carried out over 48 h. At the end of the reaction, the solution was extracted from deionized water. The methylene chloride layer was treated with saturated sodium bicarbonate solution to neutralize the acid resulting the pure compound of acetylated p-BASOPO (0.788 g, 1.171 mmol). The yield of this reaction was 71%.

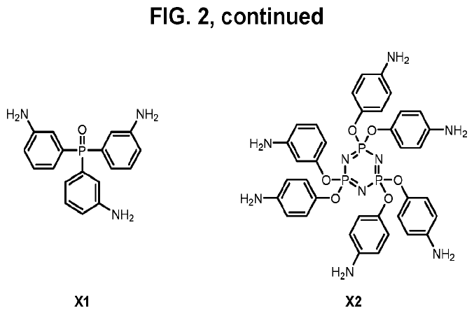

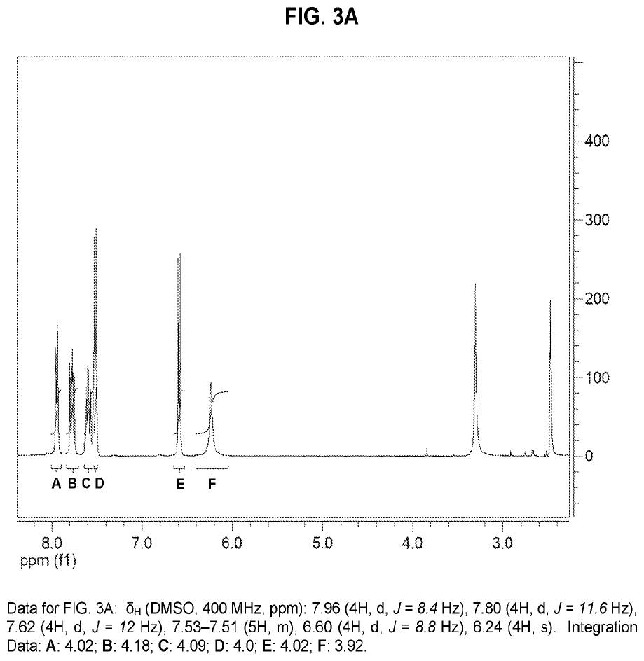

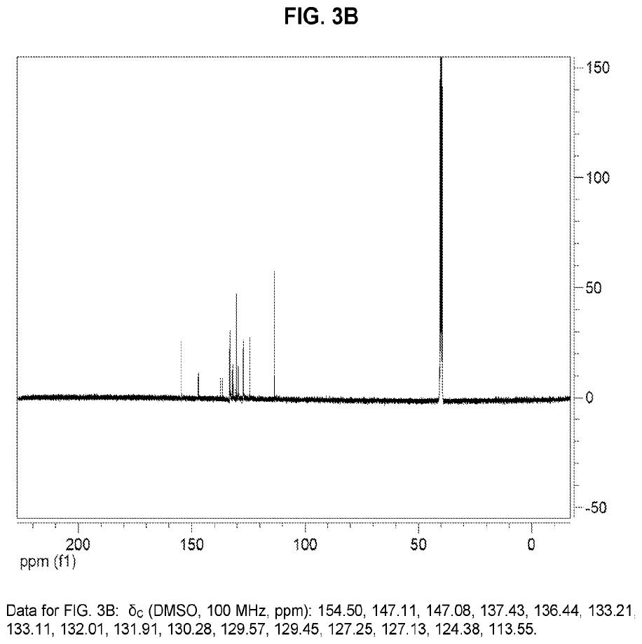

In Step 3, acetylated p-BASOPO (0.788 g, 1.171) was added to a three-necked flask containing 40 mL of methanol and 8 mL of HCl. The reaction mixture was heated under nitrogen for 48 h. At the end of the reaction, the mixture was brought to room temperature. The reaction mixture was poured into ice-cooled water in a beaker with stirring to precipitate out the compound. Saturated sodium bicarbonate solution was added to neutralize the acid. The pure compound p-BASOPO (III) (0.532 g, 0.904 mmol) was obtained by vacuum filtration. The yield of this reaction was 77%. MP: 158-160° C. Elemental analysis calculated for C₃₀H₂₅N₂O₅PS₂ (588.63): C, 61.21; H, 4.28; N, 4.76; O, 13.59; P, 5.26; S, 10.59% and found: C, 61.29; H, 4.46; N, 4.57; S, 10.60%. The ¹H (400 MHz) and ¹³C (100 MHz) NMR spectra of III are given in FIG. 3A and FIG. 3B, respectively.

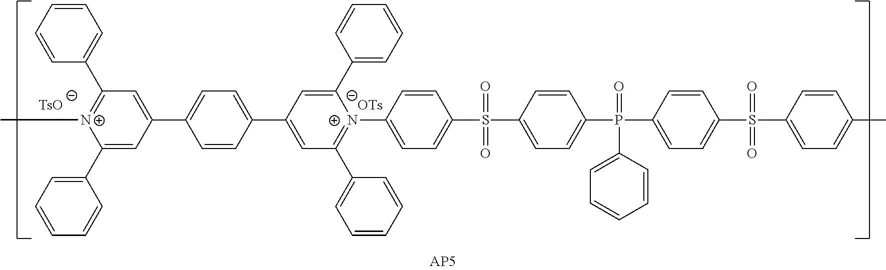

### Procedure for the Preparation of Polymer AP5 from M and III

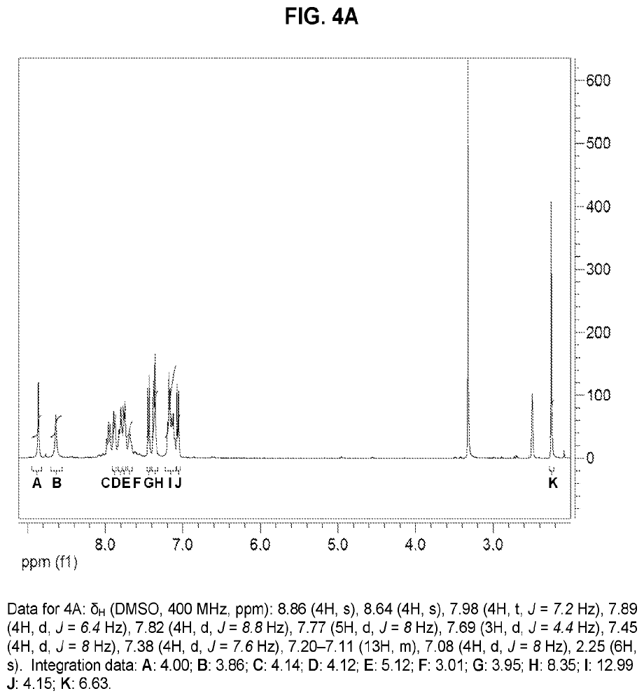

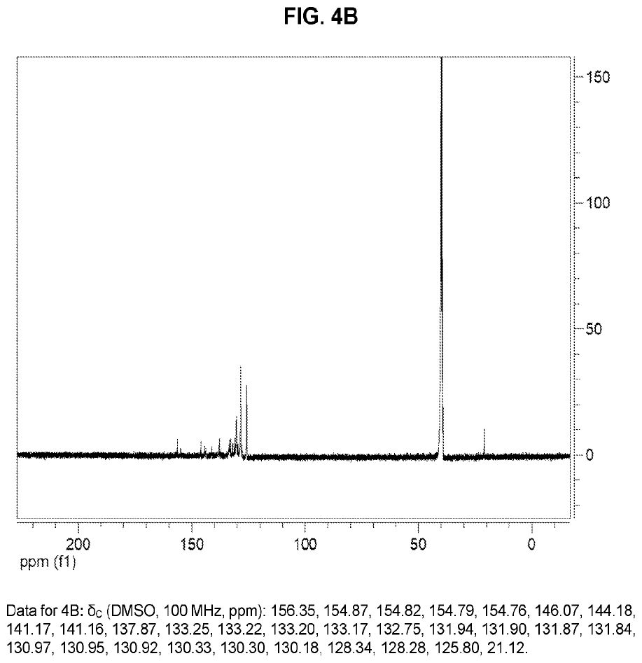

The AP5 compound was synthesized according to General Scheme 2. p-BASOPO (III) (6.15018 g, 10.4 mmol) and 4,4′-(1,4-phenylene)bis(2,6-diphenylpyrylium) tosylate salt of formula M (9.22627 g, 10.4 mmol) were added into a 250 mL 3-necked flask with 100 mL of dimethylsulfoxide. In nitrogen atmosphere, the reaction mixture was heated up to 120° C. and stirred for 48 h. After 48 h, the reaction mixture was cooled down to room temperature. A majority of the dimethyl sulfoxide was removed by using a rotary evaporator. Once the solution became viscous, the solution was poured into a beaker with water to precipitate. The solid was filtered through vacuum filtration. The polymer AP5 was washed with water several times. The pure AP5 (14.5 g, 10.1 mmol) was collected and dried in a vacuum oven for 48 h. The yield of this reaction was 97%. Elemental analysis of C₈₄H₆₃N₂O₁₁PS₄ (1435.64): calculated C, 70.28; H, 4.42; N, 1.95; O, 12.26; P, 2.16; S, 8.93%. Found % C, 67.77; H, 4.51; N, 1.80; S, 8.48%. The ¹H (400 MHz) and ¹³C (100 MHz) NMR spectra of polymer AP5 are shown in FIG. 4A and FIG. 4B, respectively.

It can be appreciated that the synthetic schemes and specific examples as described are illustrative and are not to be read as limiting the scope of the invention as it is defined in the appended claims. All alternatives, modifications, and equivalents of the synthetic methods and specific examples are included within the scope of the claims.

1. A fire-retardant polymer, the polymer comprising:
a moiety of formula (I), formula (II), or a combination thereof: 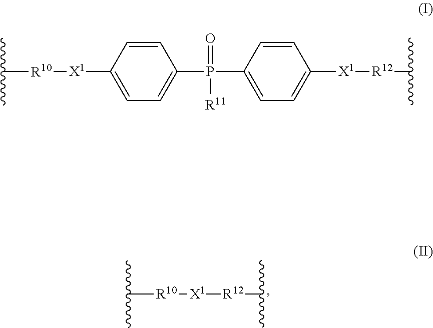
wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl; and
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and
a moiety of formula (III): 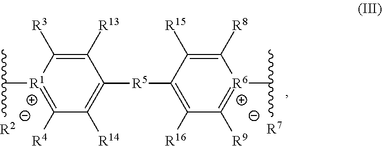
wherein:
R¹ and R⁶ are each N;
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, R⁹, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl,
with the proviso that when the polymer comprises a moiety of formula (II) wherein R¹⁰ and
R¹ are each 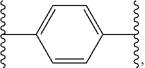 [SMILES: *c1ccc(*)cc1]
X¹ is not SO₂.

2. The polymer of claim 1, wherein the polymer is derived from a monomer of formula (M-I), formula (M-II), or a combination thereof:

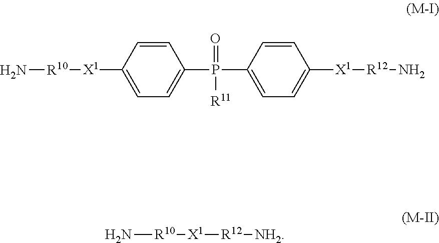

3. The polymer of claim 1, wherein R¹⁰ and R¹² are each unsubstituted phenylene.

4. The polymer of claim 1, wherein R¹¹ is unsubstituted phenyl.

5. The polymer of claim 1, wherein R² and R⁷ are each TsO⁻.

6. The polymer of claim 1, wherein R² and R⁷ are each (Tf)₂N⁻.

7. The polymer of claim 1, wherein at least one of R³, R⁴, R¹³, and R¹⁴ is an unsubstituted phenyl.

8. The polymer of claim 7, wherein R³ and R⁴ are each unsubstituted phenyl.

9. The polymer of claim 1, wherein at least one of R⁸, R⁹, R¹⁵, and R¹⁶ is an unsubstituted phenyl.

10. The polymer of claim 9, wherein R¹⁵ and R¹⁶ are each unsubstituted phenyl.

11. The polymer of claim 1, wherein the polymer comprises a polymer of formula (P-I), (P-II), or a combination thereof:

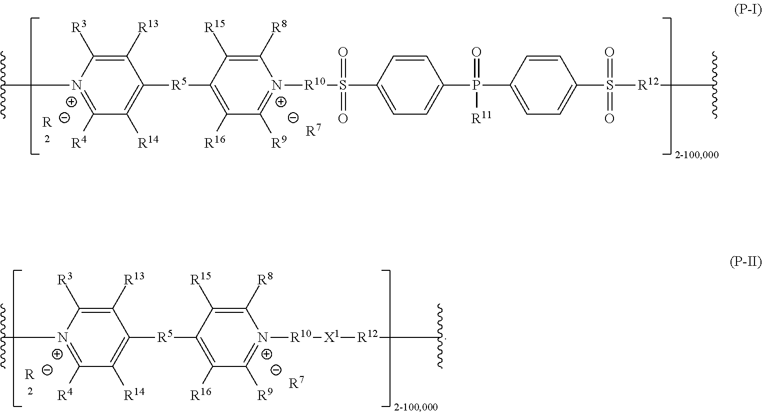

12. The polymer of claim 1, wherein the polymer is a block copolymer or a random copolymer.

13. A fire-retardant device comprising the polymer of claim 1, wherein the fire-retardant device is a window, a wooden beam, dry wall, a building construction material, a vehicle construction material, a medical device, insulation for an electrical component, a firefighter garment, a printed circuit board, or a paper-product coating.

14. A method of making a fire-retardant polymer, the method comprising reacting a monomer with a bis(pyrylium) salt, wherein:
the monomer is a monomer of formula (M-I) or (M-II): 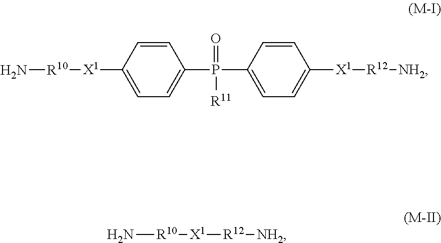
and
wherein:
X¹ is S or SO₂;
R¹⁰ and R¹² are each phenylene, wherein R¹⁰ and R¹² are each optionally substituted with 1-4 substituents, each independently selected from the group consisting of halogen, —CN, C₁₋₄alkyl, C₁₋₂haloalkyl, —OC₁₋₄alkyl, and —OC₁₋₂haloalkyl;
R¹¹ is phenyl, wherein R¹¹ is optionally substituted with 1-5 substituents, each independently selected from the group consisting of halogen, —CN, C₁₋₄alkyl, C₁₋₂haloalkyl, —OC₁₋₄alkyl, and —OC₁₋₂haloalkyl; and
the bis(pyrylium) salt is a salt of formula: 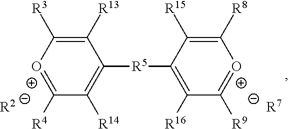
wherein:
R⁵ is phenylene, wherein R⁵ is optionally substituted 1-4 substituents, each independently selected from the group consisting of halogen, —CN, C₁₋₄alkyl, C₁₋₂haloalkyl, —OC₁₋₄alkyl, and —OC₁₋₂haloalkyl;
R² and R⁷ are each negatively charged counterions; and
R³, R⁴, R⁸, R⁹, R¹³, R¹⁴, R¹⁵, and R¹⁶, are each independently hydrogen, halogen, —CN, C₁₋₄alkyl, C₁₋₂haloalkyl, —OC₁₋₄alkyl, —OC₁₋₂haloalkyl, or phenyl, wherein the phenyl is optionally substituted with 1-3 substituents, each independently selected from the group consisting of halogen, —CN, C₁₋₄alkyl, C₁₋₂haloalkyl, —OC₁₋₄alkyl, and —OC₁₋₂haloalkyl,
with the proviso that when the monomer is a monomer of formula (M-II) wherein R¹⁰ and R¹² are each 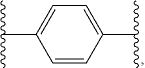 [SMILES: *c1ccc(*)cc1]
X¹ is not SO₂.

15. The method of claim 14, wherein R¹⁰, R¹¹, and R¹² are each unsubstituted phenylene.

16. (canceled)

17. The method of claim 14, wherein R² and R⁷ are each TsO⁻.

18. The method of claim 14, wherein R² and R⁷ are each (Tf)₂N⁻.

19. The method of claim 14, wherein at least one of R³, R⁴, R¹³, and R¹⁴ is an unsubstituted phenyl.

20. (canceled)

21. The method of claim 14, wherein at least one of R⁸, R⁹, R¹⁵, and R¹⁶ is an unsubstituted phenyl.

22. (canceled)

23. A method of inhibiting combustion, the method comprising applying the fire-retardant polymer of claim 1 to a material.

24-25. (canceled)
